(19) United States
(12) Patent Application Publication
(10) Pub. No.: US 2017/0135173 A1
(43) Pub. Date: May 11, 2017

(54) LIGHT CURING DEVICE

(71) Applicant: Libelle Technology Co., LTD., Tainan City (TW)

(72) Inventor: Kuo-Hsien HUANG, Tainan City (TW)

(73) Assignee: Libelle Technology Co., LTD., Tainan City (TW)

(21) Appl. No.: 15/133,366

(22) Filed: Apr. 20, 2016

(30) Foreign Application Priority Data
Nov. 5, 2015 (TW) 104217717

(51) Int. Cl. H05B 33/08; A45D 29/00

(52) U.S. Cl. CPC H05B 33/0854; H05B 33/0815; A45D 29/00

(57) ABSTRACT

A light curing device includes a housing module and a lighting module. The lighting module includes at least one light-emitting diode (LED), a driver, and a pulse width modulator. The LED is disposed at the housing module, and is configured to be driven to emit curing light. The driver is operable in an activated state. When in the activated state, the driver is operable to supply current to the at least one LED for driving the at least one LED to emit the curing light. The pulse width modulator is configured to output a pulse width modulation signal to the driver for controlling the driver to supply the current intermittently when the driver is in the activated state.

### CROSS-REFERENCE TO RELATED APPLICATION

This application claims priority of Taiwanese Application No. 104217717, filed on Nov. 5, 2015.

### FIELD

The disclosure relates to alight curing device, and more particularly to alight curing device with varying illumination period.

### BACKGROUND

A conventional light curing device is adapted to emit light on a hand or foot of a user applied with light curable product, such as gel nail polish. The light emitted by the conventional light curing device sometimes creates discomfort from a burning, pricking or tingling sensation. To escape the discomfort, the user tends to remove his/her hand or foot from the conventional light curing device in a rush. It is very easy for the user to tip over the whole device or damage the gel nail polish in this kind of circumstance.

### SUMMARY

Therefore, an object of the disclosure is to provide a light curing device that can alleviate at least one of the drawbacks of the prior art.

According to the disclosure, the light curing device includes a housing module and a lighting module. The housing module defines an irradiation space. The lighting module includes at least one light-emitting diode (LED), a driver, and a pulse width modulator. The LED is disposed at the housing module, and is configured to be driven to emit curing light into the irradiation space. The driver is electrically connected to the at least one LED, is operable in an activated state. When in the activated state, the driver is operable to supply current to the at least one LED for driving the at least one LED to emit the curing light. The pulse width modulator is electrically connected to the driver, and is configured to output a pulse width modulation signal to the driver for controlling the driver to supply the current intermittently when the driver is in the activated state.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a first embodiment of light curing device according to the disclosure;

FIG. 2 is an exploded perspective view illustrating a first embodiment of light curing device according to the disclosure;

FIG. 3 is a cross-sectional perspective view illustrating a first embodiment of light curing device according to the disclosure;

FIG. 4 is a block diagram illustrating a first embodiment of light curing device according to the disclosure;

FIG. 5 is a perspective view illustrating a second embodiment of light curing device according to the disclosure; and

FIG. 6 is a cross-sectional view illustrating a second embodiment of light curing device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

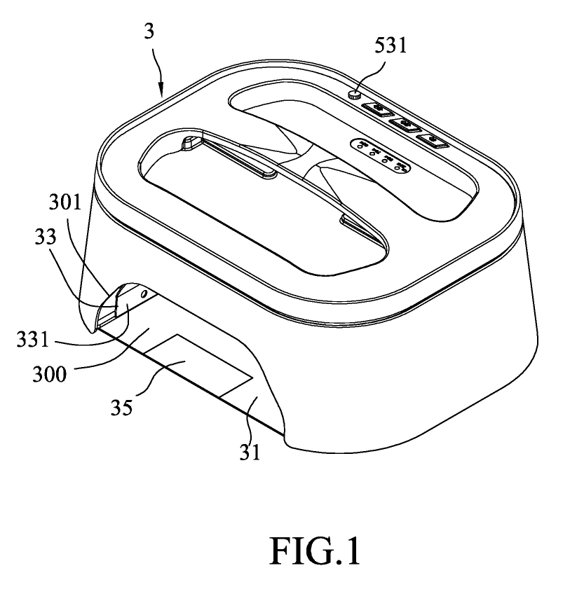

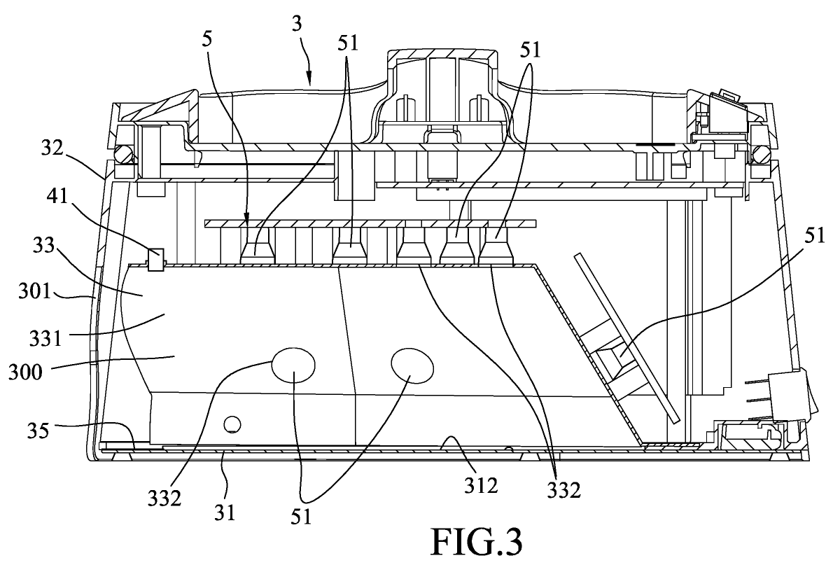

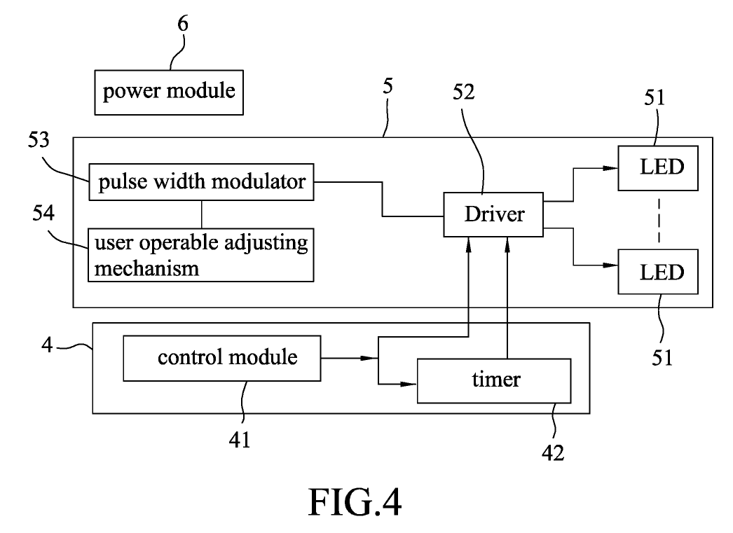

Referring to FIGS. 1 to 4, the first embodiment of a light curing device according to this disclosure is described below. The light curing device includes a housing module 3, a control module 4, a lighting module 5, and a power module 6 for supplying power.

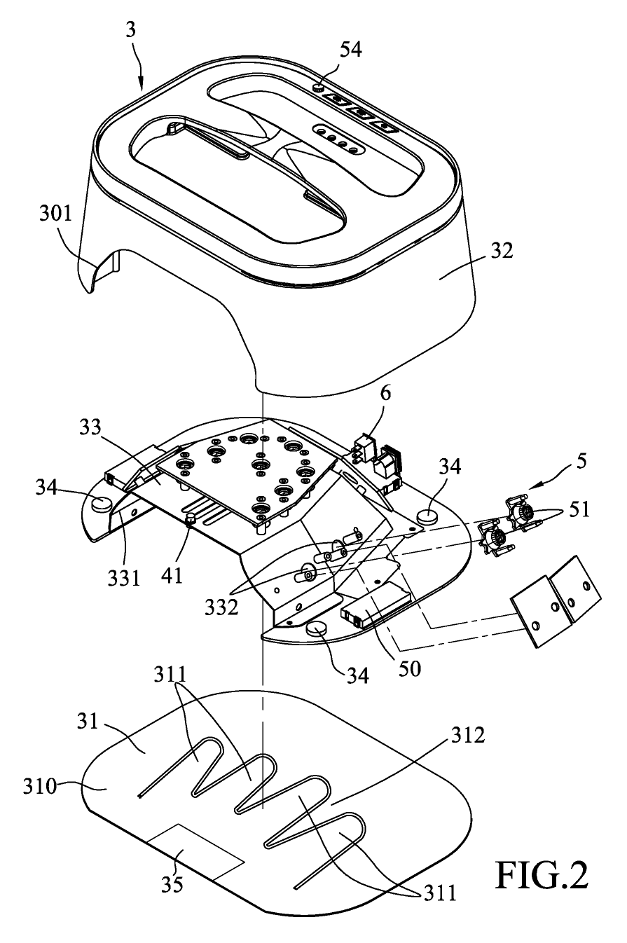

The housing module 3 includes a base 31, an outer cover 32, an inner cover 33, and a plurality of magnetic members 34 disposed at the inner cover 33 for interconnecting the inner cover 33 and the base 31. The outer cover 32 covers the inner cover 33 and the base 31 separably and is coupled to the base 31 separably, and cooperates with the inner cover 33 and the base 31 to define an irradiation space 300 and an opening 301. The opening 301 is in spatial communication with the irradiation space 300 and is configured to permit insertion of an object (e.g., a user's hand) therethrough into the irradiation space 300. The base 31 is provided with a plurality of markers 311 for positioning of fingers or toes. In this embodiment, the markers 311 are in the form of grooves and are substantially finger-shaped. A user can insert his/her hand into the irradiation space 300 with the fingers positioned about the markers 311. The base 31 has a top surface 310. The top surface 310 has a reflective zone 312 surrounding the markers 311 and capable of reflecting the curing light. The inner cover 33 has an inner reflective surface 331 that faces the base 31 and that is capable of reflecting the curing light. The top surface 312 further has an anti-reflecting zone that faces the object sensor 41 and that does not reflect the sensing light. In an embodiment, the housing module 3 further includes an anti-reflecting membrane 35 attached to the top surface 312 of the base 31 for serving as the anti-reflecting zone. As illustrated in FIG. 2, the anti-reflecting membrane 35 is disposed near the opening 301.

The lighting module 5 is disposed at the housing module 3 and includes at least one light-emitting diode (LED) 51, a driver 52, a pulse width modulator 53, and a user operable adjusting mechanism 54. In this embodiment, the lighting module 5 includes four of the LEDs 51, and each LED 51 is a UV (ultraviolet) LED. For the sake of brevity, only one LED 51 will be described. The LED 51 is disposed at the housing module 3, in particular in a corresponding mounting hole 332 in the inner cover 33 (i.e., the inner cover 33 has a plurality of mounting holes 332 for respective installation of the LEDs 51), and is configured to be driven to emit curing light, which is ultraviolet (UV) light in this embodiment, into the irradiation space 300.

The driver 52 is electrically connected to the LED 51, and is operable in an activated state. When in the activated state, the driver 51 is operable to supply current to the LED 51 for driving the LED 51 to emit the curing light. The pulse width modulator 53 is electrically connected to the driver 52, and is configured to generate and output a pulse width modulation signal to the driver 52 for controlling the driver 52 to supply the current intermittently when the driver 52 is in the activated state. The user operable adjusting mechanism 54 disposed at the outer cover 32, and is electrically connected to the pulse width modulator 53. The user is allowed to change the duty cycle of the pulse width modulation signal by operating the user operable adjusting mechanism 54, so as to vary the intermittent supply of current by the driver 52 according to the changing duty cycle. More specifically, during an ON time of the pulse width modulation signal, the driver 52 supplies the current to drive the LED 51 to emit the curing light, and during an OFF time of the pulse width modulation signal, the driver 52 does not supply the current and thus the LED 51 does not emit the curing light. The user operable adjusting mechanism 54 may be, for instance, in the form of a dial.

The control module 4 includes an object sensor 41 and a timer 42. The object sensor 41 is disposed in the irradiation space 300 and is electrically connected to the driver 52. The object sensor 41 is configured to emit sensing light toward a predetermined area within the irradiation space 300, and is capable of sensing reflected sensing light, which is the sensing light reflected by and due to presence of an object at the predetermined area. The object sensor 41 also outputs an activating signal whenever the reflected sensing light is sensed thereby. In this embodiment, the sensing light has a wavelength different from the curing light, and is infrared light. In this embodiment, the object sensor 41 is disposed at the inner cover 33 and exposed in the irradiation space 300, and positioned above the anti-reflecting membrane 35. Essentially, the anti-reflecting membrane 35 serves as the predetermined area, and the object sensor 41 emits the sensing light towards the anti-reflecting membrane 35, and in the absence of an object, the object sensor 41 will not receive reflected sensing light. When an object, such as the user's hand, blocks the anti-reflecting membrane 35 and reflects the sensing light, the object sensor 41 would receive the reflected sensing light and output the activating signal.

The timer 42 is electrically connected to the object sensor 41 and the driver 52. The timer 42 is configured to be triggered by the activating signal from the object sensor 41 to start measuring a predetermined time period, for example, 30 seconds, and outputs to the driver 52 a deactivating signal when the predetermined time period has elapsed.

The driver 52 is further operable in a deactivated state, where the supply of current to the LED 51 is disabled. The driver 52 operates in the activated state whenever the activating signal is received thereby while the deactivating signal is not received thereby, and operates in the deactivated state when otherwise. In other words, whenever the deactivating signal is received, the driver 52 operates in the deactivated state; and whenever the activating signal is not received, the driver 52 also operates in the deactivated state.

In one embodiment, the driver 52, the pulse width modulator 53 and the timer 42 are integrated into a circuit board 50. In another embodiment of this disclosure, the user operable adjusting mechanism 54 is omitted, and the pulse width modulator 53 is configured to generate the pulse width modulation signal with a predetermined varying duty cycle. With either configuration, the intermittent illumination of the curing light on the user's hand/foot alleviates the burning, pricking or tingling sensation felt by the user.

In use, as an example, for gel nail polish curing purposes, the user inserts fingers or toes applied with gel nail polish into the irradiation space 300 through the opening 301 and places the fingers or toes about the markers 311. At this time the object sensor 41 senses the reflected sensing light reflected by the user's hand or foot and outputs the activating signal, which triggers the driver 52 to operate in the activated state and drive the LEDs 51 to emit the curing light intermittently into the irradiation space 300. Since the inner cover 33 has the inner reflective surface 331 and the base 31 has the reflective zone 312, the curing light can be evenly distributed in the irradiation space 300 to effectively cure the gel nail polish. Before the predetermined time period has elapsed as measured by the timer 42, with the provision of the pulse width modulator 53, the intermittent illumination of the curing light alleviates the discomfort sensation felt by the user, during which time the user may freely remove the fingers or toes from the illumination space 300 to cease the emission of the curing light by the LEDs 51. In addition, once the predetermined time period has elapsed, the deactivating signal is outputted to trigger the driver 52 to move into the deactivated state and stop driving the LEDs 51 to emit the curing light.

It is noted that, since the base 31 and the outer cover 32 are separable, in use, the user may opt to place the fingers or toes on a surface, such as a tabletop, separate the base 31 from the light curing device, and cover the fingers or toes can also cover his/her hand or foot with the remainder of the light curing device.

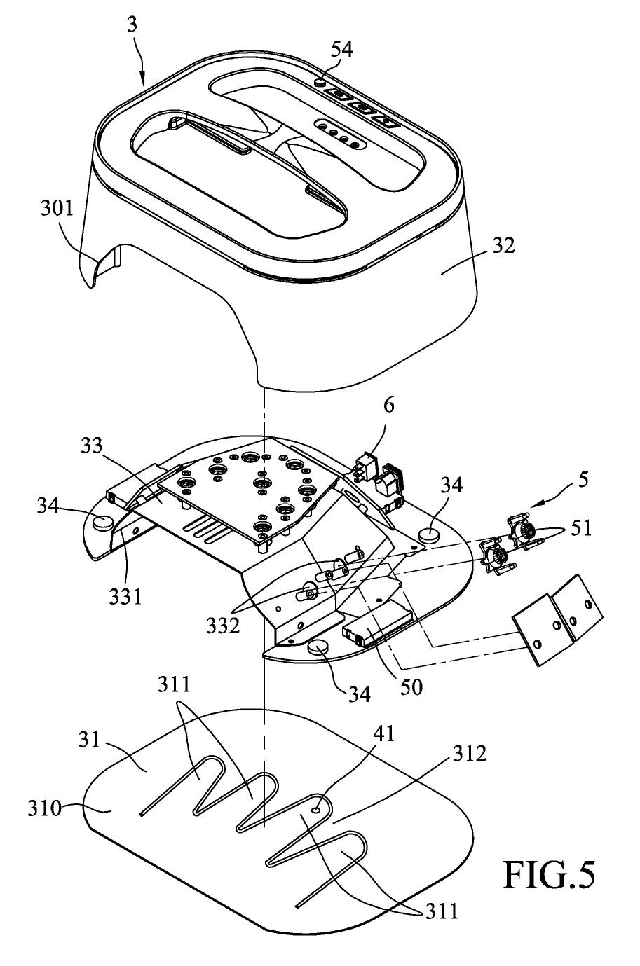

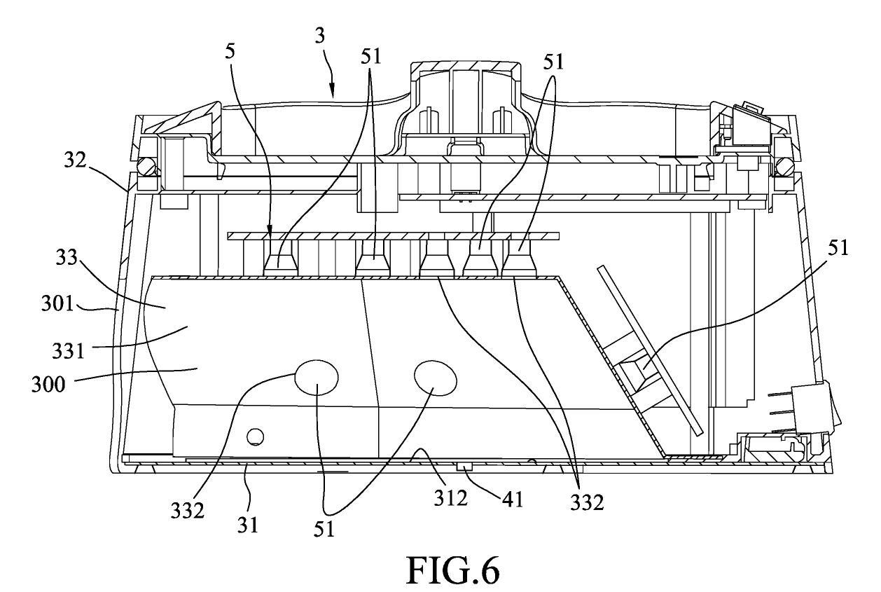

Referring to FIGS. 5 and 6, a second embodiment of a light curing device according to this disclosure is described below. The second embodiment differs from the first embodiment mainly in that the object sensor 41 is mounted co-movably to the base 31 and has a first terminal (not shown) fixed at the base 31, and the lighting module 5 has a second terminal (not shown) disposed at the outer cover 32 or the inner cover 33 and configured to be electrically and separably connected to the first terminal so as to electrically connect the object sensor 41 to the driver 52 of the lighting module 5. Further, different from the first embodiment, there is no anti-reflecting membrane 35 or anti-reflecting zone in the second embodiment. The object sensor 41 may be configured to be able to sense reflected sensing light within such a limited range that the fingers or toes placed in the illumination space 300 will be determined. The description of the other similar structure and operation will be omitted for the sake of brevity.

In sum, the user can prevent the hand get burning feelings by adjusting the mechanism 54. The LED 51 automatically turns off after the timer 42 finishing counting or the object sensor 41 sensing no hand or foot in the light curing device, this means the hand or the foot is pulling out of the light curing device. Thus, the nervousness feeling of the user will be decreased and the safety will be increased.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A light curing device comprising:
a housing module defining an irradiation space; and
a lighting module including
at least one light-emitting diode (LED) that is disposed at said housing module, and that is configured to be driven to emit curing light into the irradiation space,
a driver that is electrically connected to said at least one LED, that is operable in an activated state, and that is operable, when in the activated state, to supply current to said at least one LED for driving said at least one LED to emit the curing light, and
a pulse width modulator that is electrically connected to said driver, and that is configured to output a pulse width modulation signal to said driver for controlling said driver to supply the current intermittently when said driver is in the activated state.

2. The light curing device as claimed in claim 1, wherein said lighting module further includes a user operable adjusting mechanism disposed at said housing module, electrically connected to said pulse width modulator, and operable for changing a duty cycle of the pulse width modulation signal.

3. The light curing device as claimed in claim 1, wherein said pulse width modulator is configured to generate the pulse width modulation signal with a varying duty cycle.

4. The light curing device as claimed in claim 1, further comprising a control module including:
an object sensor that is disposed in the irradiation space, that is electrically connected to said driver, that is configured to emit sensing light toward a predetermined area within the irradiation space, that is capable of sensing reflected sensing light, which is the sensing light reflected by and due to presence of an object at the predetermined area, and that outputs to said driver an activating signal whenever the reflected sensing light is sensed thereby; and
a timer that is electrically connected to said object sensor and said driver, that is configured to be triggered by the activating signal to start measuring a predetermined time period, and that outputs to said driver a deactivating signal when the predetermined time period has elapsed;
wherein said driver is further operable in a deactivated state, where the supply of current to said at least one LED is disabled;
wherein said driver operates in the activated state whenever the activating signal is received thereby while the deactivating signal is not received thereby, and operates in the deactivated state when otherwise.

5. The light curing device as claimed in claim 4, wherein the sensing light has a wavelength different from the curing light.

6. The light curing device as claimed in claim 4, wherein said housing module includes a base and a cover covering and coupled to said base, and cooperating with said base to define the irradiation space and an opening that is in spatial communication with the irradiation space and that is configured to permit insertion of an object therethrough into the irradiation space, said base being provided with a plurality of markers for positioning of fingers or toes.

7. The light curing device as claimed in claim 6, wherein said object sensor is mounted co-movably to said base and has a first terminal fixed at said base, and said lighting module has a second terminal disposed at said cover and configured to be electrically and separably connected to said first terminal so as to electrically connect said object sensor to said driver of said lighting module.

8. The light curing device as claimed in claim 6, wherein said object sensor is disposed at said cover.

9. The light curing device as claimed in claim 8, wherein said base has a top surface having an anti-reflecting zone that faces said object sensor and that does not reflect the sensing light.

10. The light curing device as claimed in claim 9, wherein said housing module further includes an anti-reflecting membrane attached to said top surface of said base for serving as the anti-reflecting zone.

11. The light curing device as claimed in claim 6, wherein said cover covers and is coupled to said base separably, and said housing module further includes at least one magnetic member for interconnecting said cover and said base.

12. The light curing device as claimed in claim 6, wherein said markers are in the form of grooves.

13. The light curing device as claimed in claim 6, wherein said base has a top surface that has a reflective zone surrounding said markers and capable of reflecting the curing light, and said cover has an inner reflective surface that is capable of reflecting the curing light.

14. The light curing device as claimed in claim 1, wherein the curing light is ultraviolet (UV) light.

15. The light curing device as claimed in claim 1, wherein said housing module includes a base, an inner cover disposed on said base and having an inner reflective surface that faces said base for reflecting the curing light emitted by said at least one LED, and an outer cover covering said inner cover and said base, coupled to said base, and cooperating with said inner cover and said base to define the irradiation space.
